(19) United States
(12) Patent Application Publication
(10) Pub. No.: US 2017/0066059 A1
(43) Pub. Date: Mar. 9, 2017

(54) CNC TURNING AND MILLING MACHINE

(71) Applicant: CHU-NENG YU, Taichung City (TW)

(72) Inventor: CHU-NENG YU, Taichung City (TW)

(21) Appl. No.: 15/157,379

(22) Filed: May 17, 2016

(30) Foreign Application Priority Data
Sep. 9, 2015 (TW) 104214570

(51) Int. Cl. B23B 11/00; B23B 29/24; B23C 7/02

(52) U.S. Cl. CPC B23B 11/00; B23C 7/02; B23B 29/24

(57) ABSTRACT

A CNC turning and milling machine includes: a base, a platform, combined movable device, a turret rack, a turret, a main shaft seat, a main shaft, and a tool magazine. The turret rack and the main shaft seat are disposed on the combined movable device, the turret is disposed on the turret rack, and the main shaft is mounted on the main shaft seat, so that the milling and turning operation can be performed simultaneously by a single machine, without the disadvantage of the conventional CNC turning and milling machine which has a less rigid structure. The power of the main shaft is increase by 300 percent.

### CROSS REFERENCE TO RELATED APPLICATION

This application claims the benefit of priority to TW 104214570, filed on Sep. 9, 2015 with the Intellectual Property Office of the Republic of China, Taiwan, the entire specification of which is incorporated herein by reference.

### BACKGROUND

Field of the Invention

The present invention relates to a machine, and more particularly to a CNC turning and milling machine.

Related Prior Art

A combined turning and milling machine normally comprises a powered tool disposed on a turning machine, the tool is capable of rotating, like the milling machine, which enables to the turning machine to perform milling operations. However, the shaft of the turning machine is not rigid enough to withstand the rotation torque of the power tool. When a large amount of milling and turning work is performed, the combined turning and milling machine is likely to be damaged.

The present invention has arisen to mitigate and/or obviate the afore-described disadvantages.

### SUMMARY

The present invention is aimed at providing a CNC turning and milling machine, which has a strengthened structure and is easy to use.

Therefore, a CNC turning and milling machine in accordance with the present invention comprises:
a base including a first end and a second end, a direction extending from the first end to the second end being defined as an axial direction, the first end including a first lateral end and an opposite second lateral end, a direction extending from the first lateral end to the second lateral end being defined as a radial direction;
a platform disposed on the base, and including a clamping device, wherein the clamping device serves to clamp a workpiece to be processed, and is capable of rotating;
a combined movable device including a mounting seat and an upright member which is mounted on the mounting seat opposite the base and movable along the radial direction, wherein the upright member has one side located toward the platform, and the mounting seat is disposed on the base and movable along the axial direction, a direction extending from the mounting seat to the upright member is defined as a height direction;
a turret rack being mounted on the upright member and movable along the radial direction;
a turret mounted on the turret rack and provided for mounting of at least one turret rack;
a main shaft seat being mounted on the side of the upright member which is located toward the platform, and the main shaft seat being movable along the height direction; and
a main shaft being disposed on the main shaft seat, and provided for mounting of a milling tool which has one end connected to the main shaft, another end of the milling tool is a working head which is located toward the base.

The turret rack and the main shaft seat are disposed on the combined movable device, the turret is disposed on the turret rack, and the main shaft is mounted on the main shaft seat, so that the milling and turning operation can be performed simultaneously by a single machine, without the disadvantage of the conventional CNC turning and milling machine which has a less rigid structure.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an exploded view showing a CNC turning and milling machine in accordance with the preferred embodiment of the present invention;

FIG. 2 is an assembly view showing the CNC turning and milling machine in accordance with the preferred embodiment of the present invention;

FIG. 3 is an operational view showing the CNC turning and milling machine in accordance with the preferred embodiment of the present invention;

FIG. 4 is another operational view showing the CNC turning and milling machine in accordance with the preferred embodiment of the present invention;

FIG. 5 is another operational view showing the CNC turning and milling machine in accordance with the preferred embodiment of the present invention;

FIG. 6 is another operational view showing the CNC turning and milling machine in accordance with the preferred embodiment of the present invention;

FIG. 7 is another operational view showing the CNC turning and milling machine in accordance with the preferred embodiment of the present invention; and

FIG. 8 is another operational view showing the CNC turning and milling machine in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

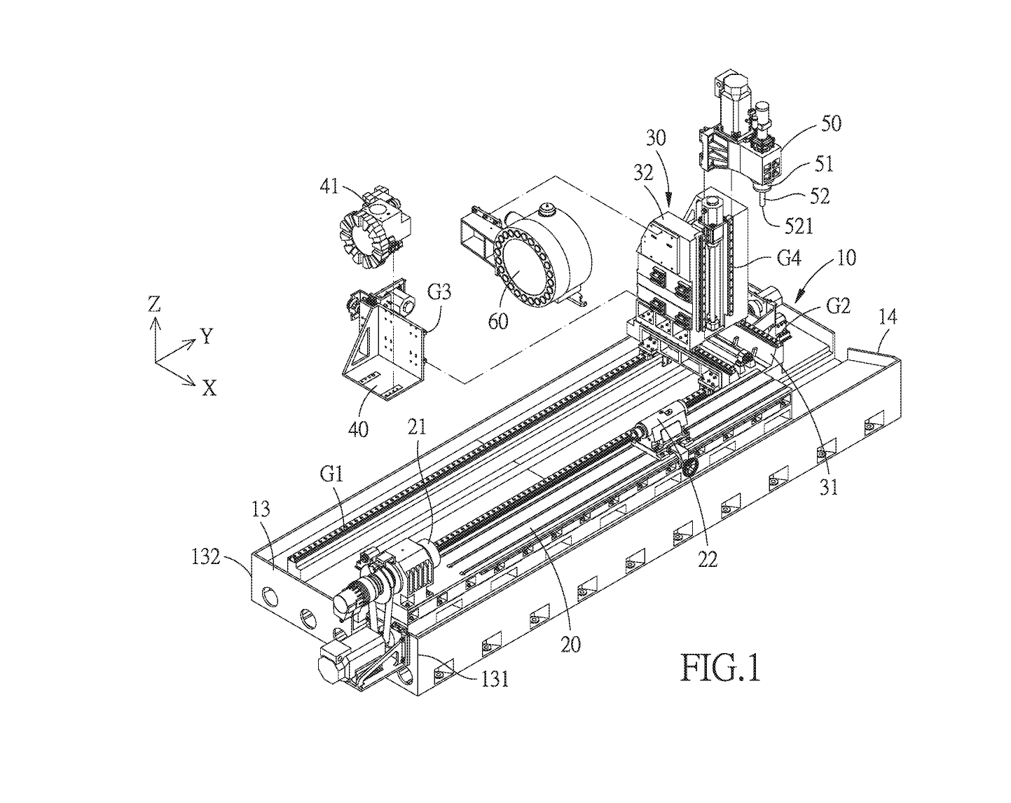

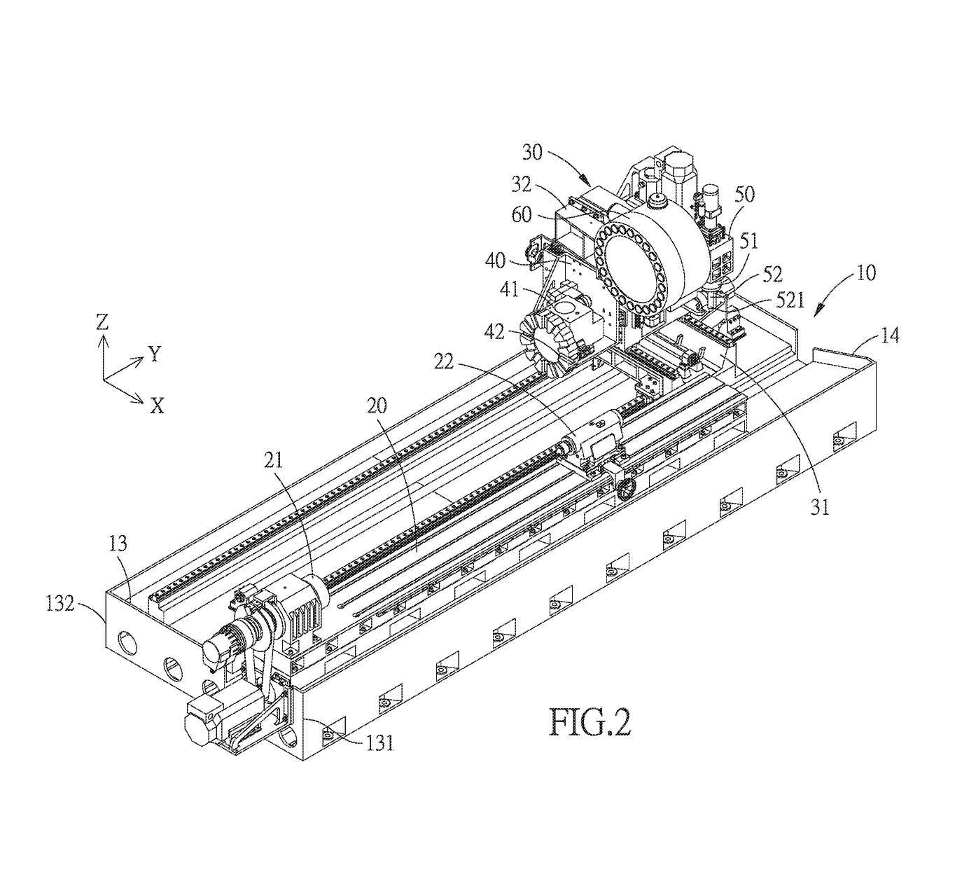

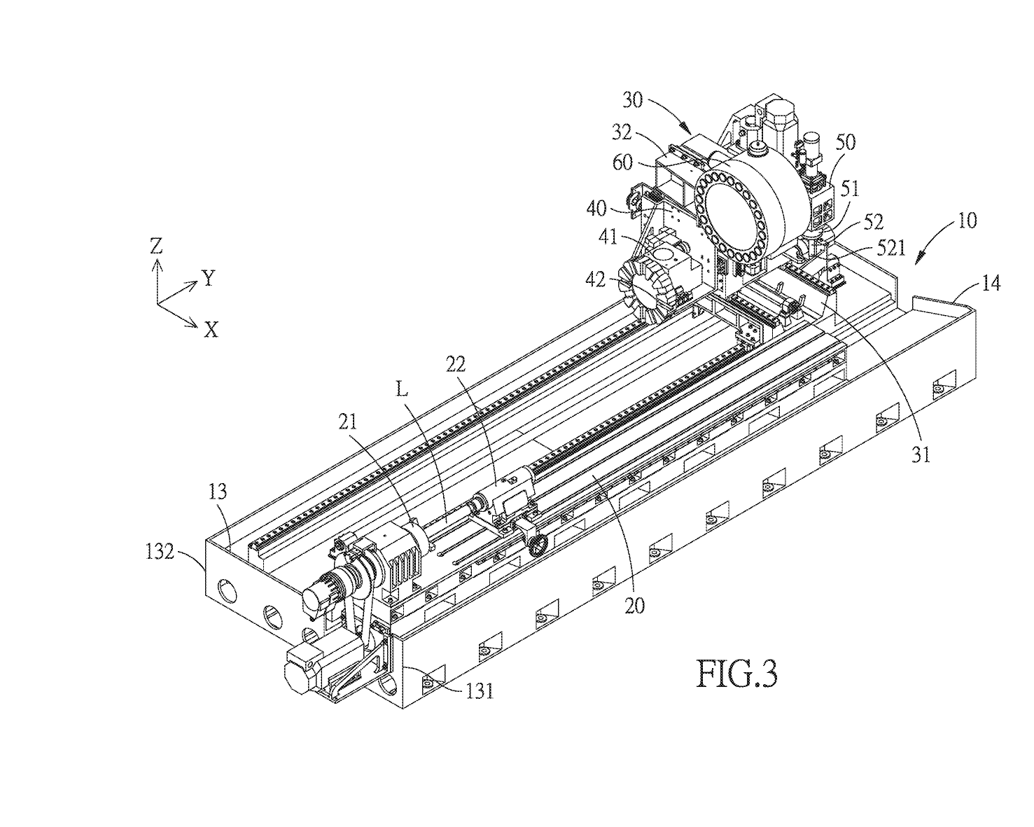

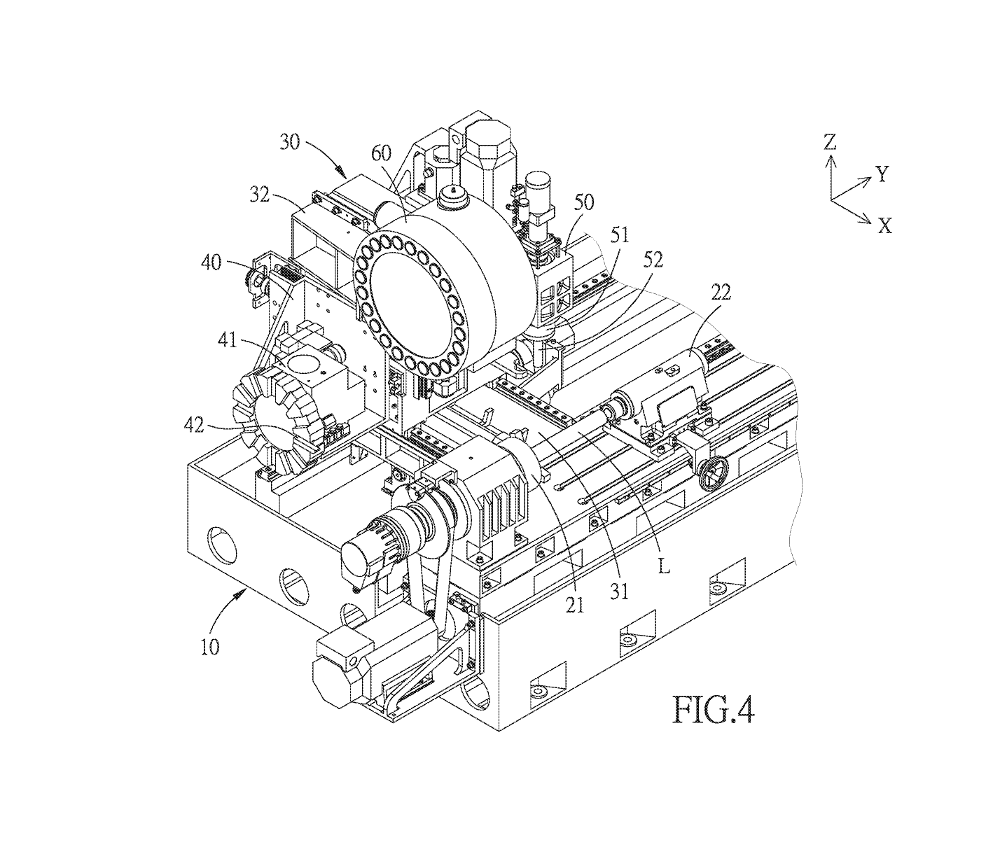

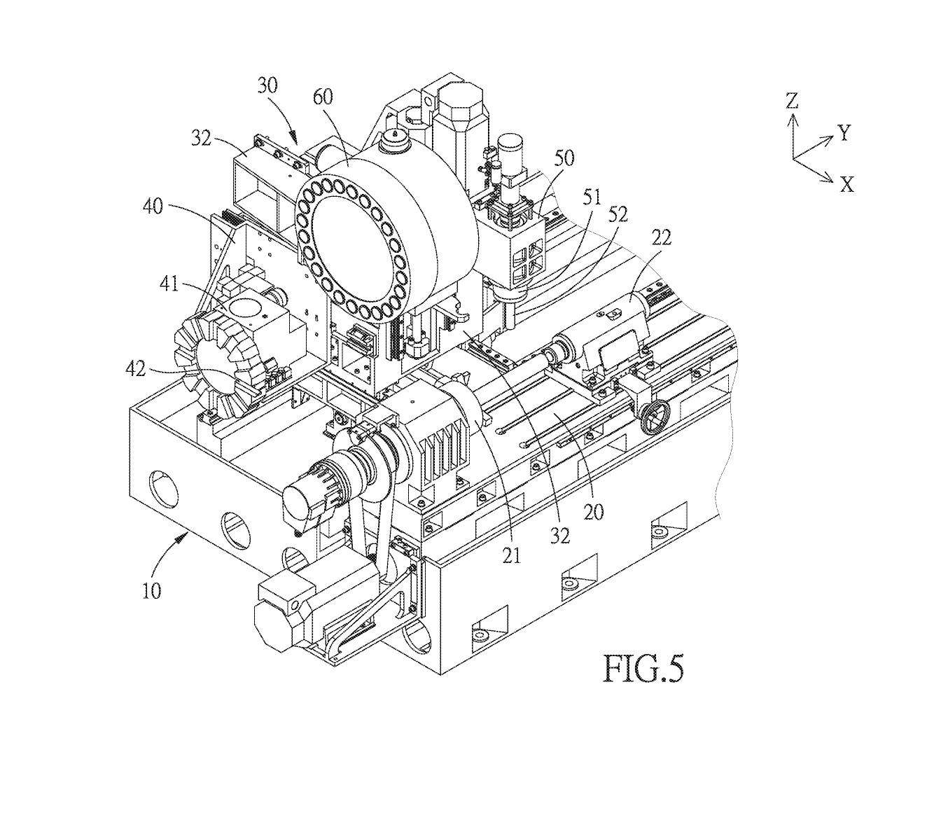

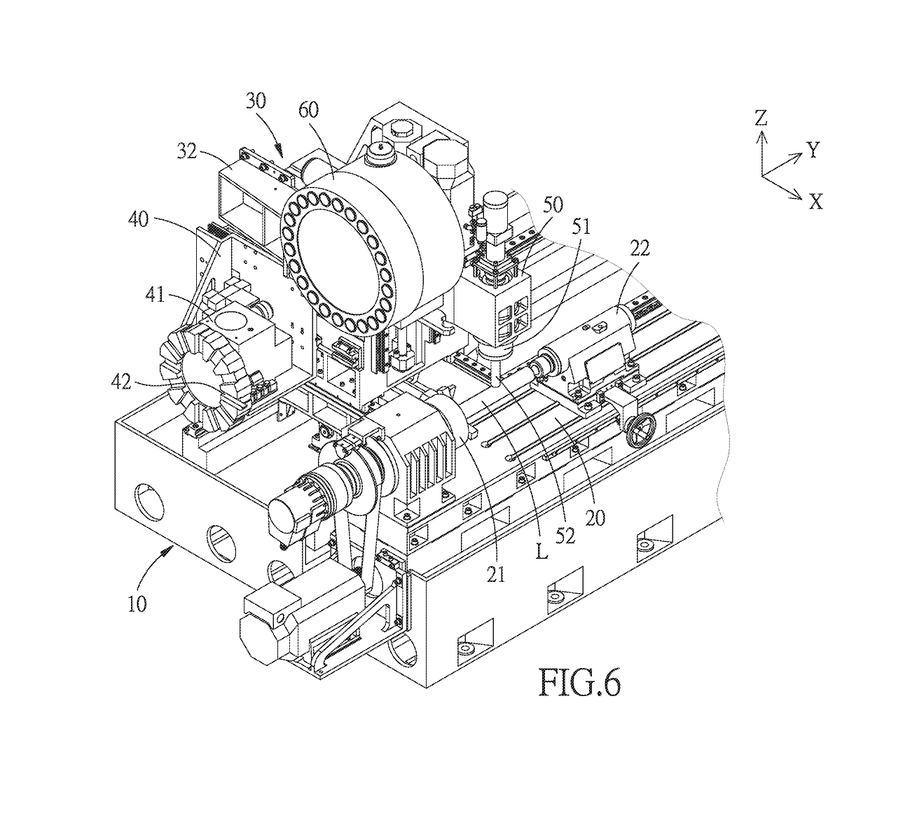

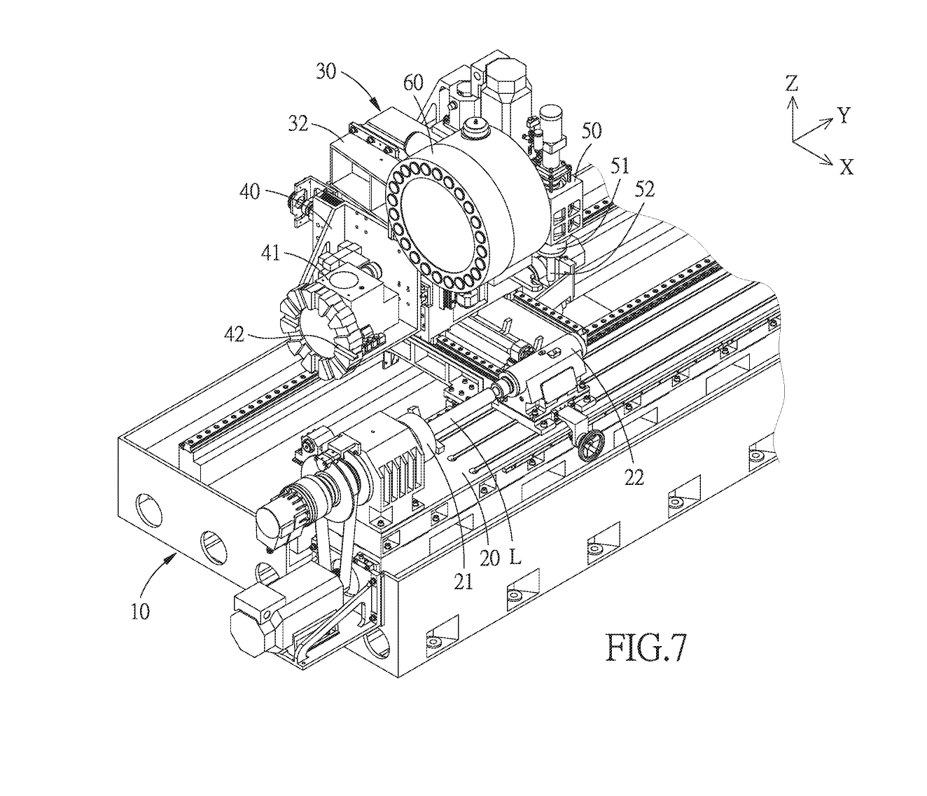

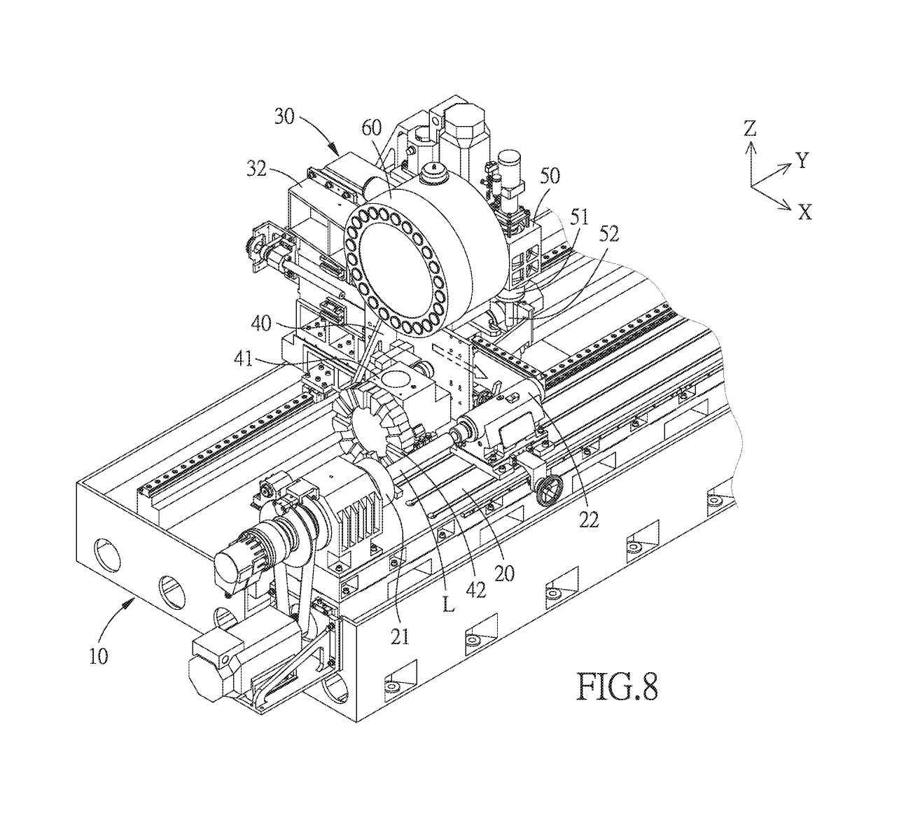

Referring to FIGS. 1-8, a CNC turning and milling machine in accordance with the preferred embodiment of the present invention, comprises: a base 10, a platform 20, combined movable device 30, a turret rack 40, a turret 41, a main shaft seat 50, a main shaft 51, and a tool magazine 60,

The base 10 includes a first end 13 and a second end 14. A direction extending from the first end 13 to the second end 14 is defined as an axial direction Y. The first end 13 includes a first lateral end 131 and an opposite second lateral end 132, and a direction extending from the first lateral end 131 to the second lateral end 132 is defined as a radial direction X.

The platform 20 is disposed on the base 10, and includes a clamping device 21 and a press device 22 which is located a distance from the clamping device 21. The clamping device 21 serves to clamp a workpiece L to be processed, and is capable of rotating. The press device 22 is disposed on the platform 20 and movable along the axial direction Y to press the workpiece L clamped by the clamping device 21. Moving the press device 22 along the axial direction Y can adjust the distance between the clamping device 21 and the press device 22 to fit the size of various sized workpieces L.

The combined movable device 30 includes a mounting seat 31 and an upright member 32 which is mounted on one side of the mounting seat 31 opposite the base 10 and movable along the radial direction X. The upright member 32 has one side located toward the platform 20. A direction extending from the mounting seat 31 to the upright member 32 is defined as a height direction Z which is perpendicular to the axial direction Y and the radial direction X.

The turret rack 40 is mounted on the upright member 32 and movable along the radial direction X.

The turret 41 is mounted on the turret rack 40 and provided for mounting of at least one turret rack 40.

The main shaft seat 50 is mounted on the side of the upright member 32 which is located toward the platform 20, and movable along the height direction Z.

The main shaft 51 is disposed on the main shaft seat 50, and provided for mounting and rotating of a milling tool 52 which has one end connected to the main shaft 51. Another end of the milling tool 52 is a working head 521 which is located toward the base 10.

The tool magazine 60 is mounted on the upright member 32 and located adjacent to the main shaft seat 50. The tool magazine 60 is provided with at least one milling tool 52 which can be selectively attached to the main shaft 51.

Preferably, two first linear guideways G1 are spaced apart on the base 10 and extend along the axial direction Y. Two second linear guideways G2 are spaced apart on the one side of the mounting seat 31 opposite the base 10 and extend along the radial direction X. The upright member 32 is disposed on the two second linear guideways G2, and therefore movable along the radial direction X. Two third linear guideways G3 are spaced apart on one side of the turret rack 40 located toward the upright member 32 and extend along the radial direction X, so that the turret rack 40 is able to move along the radial direction X with respect to the upright member 32. Two fourth linear guideways G4 are spaced apart on one side of the upright member 32 located toward the main shaft seat 50 and extend in the height direction Z, so that the main shaft seat 50 is able to move along the height direction Z with respect to the height direction Z.

When in use, the clamping device 21 clamps the workpiece L to be processed, and the press device 22 presses against the workpiece L. To perform turning operation on the workpiece L, the user can make the clamping device 21 rotate to rotate the workpiece L, then the mounting seat 31 moves along the axial direction Y to move the turret 41 to the workpiece L, then the upright member 32 moves in the radial direction X, and a turning tool 42 in the turret 41 perform turning operation. Moving the turret rack 40 along the radial direction X, and controlling the distance between the turning tool 42 and the workpiece L can control the depth of turning operation.

To perform milling operation on the workpiece L, the user can let the clamping device 21 stay put, then the mounting seat 31 moves along the axial direction Y to move the main shaft 51 to the workpiece L to be processed, then the upright member 32 moves along the radial direction X to move the turning tool 42 to the workpiece L, then a milling tool 52 performs the milling operation. Moving the main shaft seat 50 in the height direction Z, and controlling the distance between the milling tool 52 and the workpiece L can control the depth of milling operation.

While we have shown and described various embodiments in accordance with the present invention, it is clear to those skilled in the art that further embodiments may be made without departing from the scope of the present invention.

What is claimed is:

1. A CNC turning and milling machine, comprising:
a base including a first end and a second end, a direction extending from the first end to the second end being defined as an axial direction, the first end including a first lateral end and an opposite second lateral end, a direction extending from the first lateral end to the second lateral end being defined as a radial direction;
a platform disposed on the base, and including a clamping device, wherein the clamping device serves to clamp a workpiece to be processed, and is capable of rotating;
a combined movable device including a mounting seat and an upright member which is mounted on the mounting seat opposite the base and movable along the radial direction, wherein the upright member has one side located toward the platform, and the mounting seat is disposed on the base and movable along the axial direction, a direction extending from the mounting seat to the upright member is defined as a height direction;
a turret rack being mounted on the upright member and movable along the radial direction;
a turret mounted on the turret rack and provided for mounting of at least one turret rack;
a main shaft seat being mounted on the side of the upright member which is located toward the platform, and the main shaft seat being movable along the height direction; and
a main shaft being disposed on the main shaft seat, and provided for mounting of a milling tool which has one end connected to the main shaft, another end of the milling tool is a working head which is located toward the base.

2. The CNC turning and milling machine as claimed in claim 1, wherein the platform further includes a press device which is located a distance from the clamping device, and the press device is disposed on the platform and movable along the axial direction to press the workpiece clamped by the clamping device.

3. The CNC turning and milling machine as claimed in claim 1 further comprising a tool magazine which is mounted on the upright member and located adjacent to the main shaft seat, and the tool magazine is provided with at least one said milling tool.
